(19) United States
(12) Patent Application Publication
(10) Pub. No.: US 2024/0361156 A1
(43) Pub. Date: Oct. 31, 2024

(54) SENSOR APPARATUS

(71) Applicant: ALPS ALPINE CO., LTD., Tokyo (JP)

(72) Inventor: Takeshi MASAKI, Miyagi (JP)

(21) Appl. No.: 18/763,445

(22) Filed: Jul. 3, 2024

Related U.S. Application Data
(63) Continuation of application No. PCT/JP2022/038685, filed on Oct. 18, 2022.

(30) Foreign Application Priority Data
Jan. 14, 2022 (JP) 2022-004585

(51) Int. Cl. G01D 5/24; B62D 1/04

(52) U.S. Cl. CPC G01D 5/24; B62D 1/046

(57) ABSTRACT

A sensor apparatus includes a sensor electrode provided on a base material; a shield electrode provided on the base material so as to surround an outer edge of the sensor electrode and configured to capacitively couple with the sensor electrode; a voltage circuit connected to the shield electrode and configured to output an AC voltage having a predetermined phase and a predetermined voltage; and a protection circuit including a first end part connected to a connection part between the voltage circuit and the shield electrode and a second end part connected to ground.

### CROSS-REFERENCE TO RELATED APPLICATION

The present application is a continuation application of International Application No. PCT/JP2022/038685 filed on Oct. 18, 2022, which is based on and claims priority to Japanese Patent Application No. 2022-004585 filed on Jan. 14, 2022. The contents of these applications are incorporated herein by reference in their entirety.

### BACKGROUND OF THE INVENTION

### 1. Field of the Invention

The present invention relates to a sensor apparatus.

### 2. Description of the Related Art

Conventionally, there has been provided a capacitive sensor apparatus incorporated in a steering wheel, wherein the steering wheel has a rim and a spoke connected to the inside of the rim, the sensor apparatus includes an electrode capable of capacitively coupling with an object to be detected and a control unit, the sensor apparatus is provided on the spoke, and the control unit detects a change in the capacitance of the electrode generated when the object is brought into proximity with the rim or the spoke, and determines whether the object is brought into proximity based on the change in the capacitance (see, e.g., Patent Document 1).

There is also a known technique for using a sensor apparatus for determining whether an object is in proximity or not based on a change in capacitance as a sensor for detecting an approach to a touch pad or door handle (for example, see Patents 2 and 3).
[Patent Document 1] WO 2020/195620
[Patent Document 2] Japanese Laid-open Patent Publication No. 2018-081573
[Patent Document 3] Japanese Laid-open Patent Publication No. 2020-133150

### SUMMARY OF THE INVENTION

According to one aspect of the present invention, there is provided a sensor apparatus including a sensor electrode provided on a base material; a shield electrode provided on the base material so as to surround an outer edge of the sensor electrode and configured to capacitively couple with the sensor electrode; a voltage circuit connected to the shield electrode and configured to output an AC voltage having a predetermined phase and a predetermined voltage; and a protection circuit including a first end part connected to a connection part between the voltage circuit and the shield electrode and a second end part connected to ground.

### BRIEF DESCRIPTION OF THE DRAWINGS

FIG. 1A is a diagram transparently illustrating the configuration of the steering wheel of a first embodiment;

FIG. 1B is a diagram illustrating the detection area of the steering wheel sensor of the first embodiment;

FIG. 1C is a diagram illustrating a part of the configuration of the steering wheel sensor of the first embodiment;

FIG. 1D is a block diagram illustrating the steering wheel sensor of the first embodiment;

FIG. 2A is a diagram illustrating the configuration of the steering wheel sensor of the first embodiment;

FIG. 2B is a diagram illustrating a sensor apparatus for comparison;

FIG. 3 is a diagram illustrating the configuration of the spoke portion of the steering wheel and the area surrounding the spoke according to a first modified example of the first embodiment;

FIG. 4 is a diagram illustrating the capacitive sensor according to the first modified example of the first embodiment;

FIG. 5A illustrates a configuration of a capacitive sensor according to a second modified example of the first embodiment;

FIG. 5B illustrates a configuration of a capacitive sensor according to a third modified example of the first embodiment;

FIG. 6A illustrates a PC including a sensor apparatus according to a second embodiment;

FIG. 6B illustrates a sensor apparatus according to the second embodiment;

FIG. 7A illustrates a door handle to which the sensor apparatus according to a third embodiment is applied; and

FIG. 7B illustrates a sensor apparatus according to the third embodiment.

### DETAILED DESCRIPTION OF THE PREFERRED EMBODIMENTS

In the conventional sensor apparatus, a capacitance sensor is formed by a conductor wire or the like and is provided at the edge of the spoke, and there is an influence by the floating capacitance. Further, the sensor electrode is arranged at the spoke in contact with a person, and, therefore, it is necessary to arrange the electrode so as not to be exposed so as not to damage the sensor electrode by static electricity, and there has been a problem that the structure becomes complicated.

It is an object of the present invention to provide a sensor apparatus capable of preventing the influence of the floating capacitance on the detection value of the sensor electrode and the damage by static electricity.

Hereinafter, an embodiment in which the sensor apparatus of the present disclosure is applied will be described.

### First Embodiment

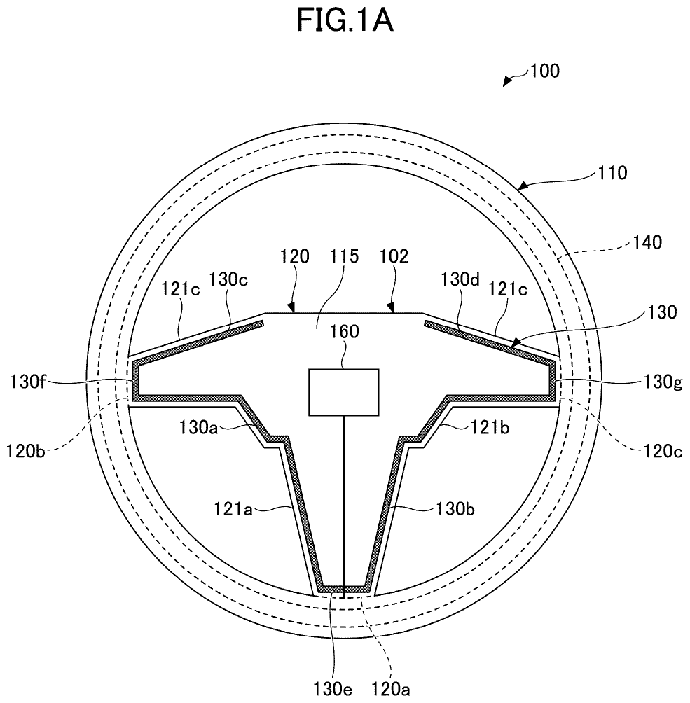

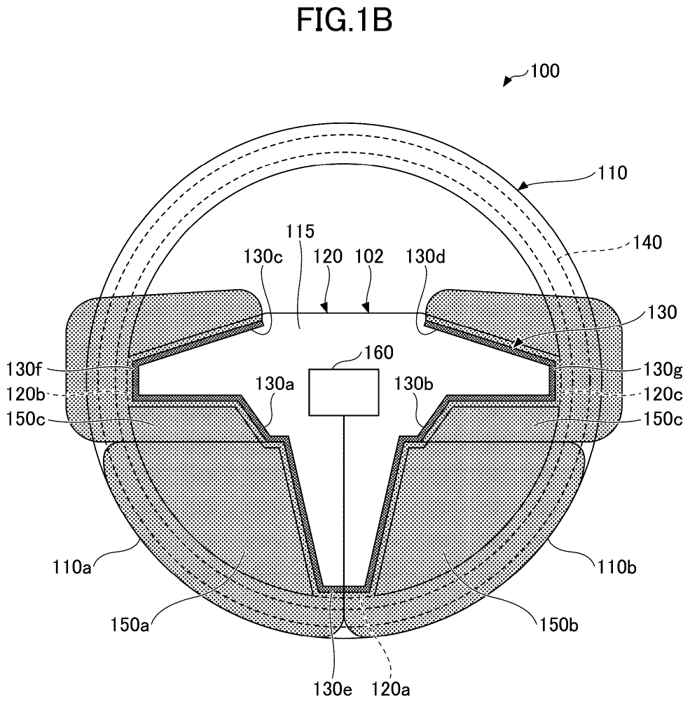

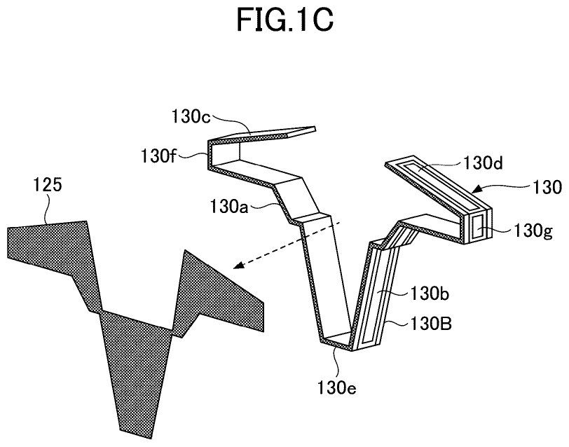

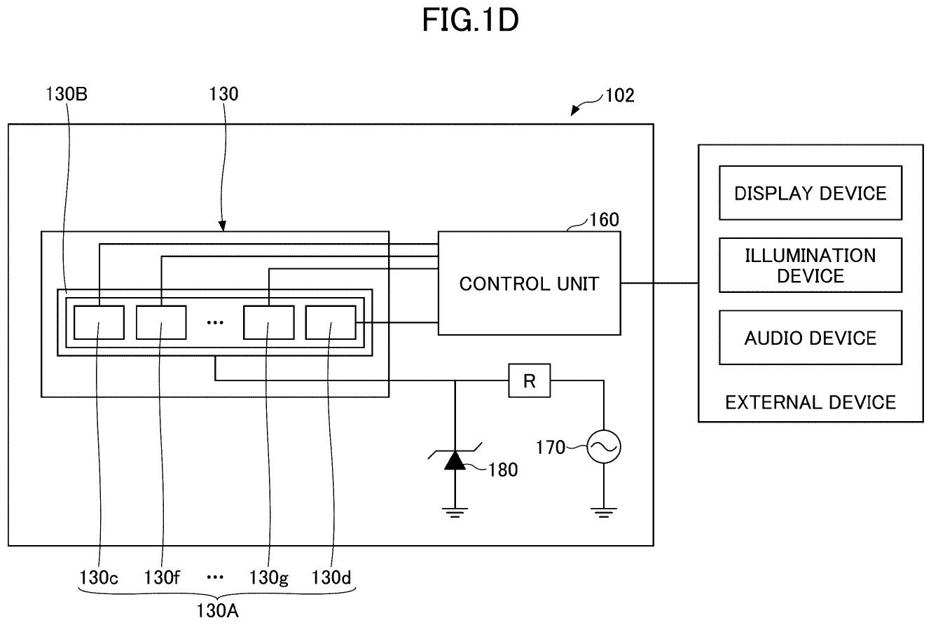

A steering wheel sensor 102 (an example of a “sensor apparatus”) and a steering wheel 100 (an example of a “steering wheel”) will be described with reference to FIGS. 1A to 1D. As illustrated in FIG. 1A, the steering wheel 100 of first embodiment includes a rim 110, a hub 115 connected to the inner side of the rim 110 and connected to a rotation shaft (not illustrated) and located at the center of the steering wheel 100, a spoke 120 connecting the hub 115 and the rim 110, and a steering wheel sensor 102 provided on the spoke 120. FIGS. 1A and 1B illustrate the steering wheel 100 in a neutral state. The neutral state means the position of the steering wheel 100 in a state in which the steering wheel 100 is not steered and the vehicle is moving straight.

The steering wheel sensor 102 includes a capacitive sensor 130 capable of capacitively coupling with an object (in the following, an operation body) to be detected, such as a human hand, a control unit 160 (an example of a “determining unit”), a voltage circuit, and a protection circuit. The steering wheel sensor 102 may not include the control unit 160, and the control unit 160 may be provided outside the steering wheel sensor 102.

The capacitive sensor 130 is provided along the edges 121a, 121b, 121c of the spoke 120 facing the inner peripheral surface of the rim 110. The capacitive sensor 130 has a sensor electrode and a shield electrode. The sensor electrode is an electrode capable of detecting the capacitance between the sensor electrode and the operation body and the shield electrode is an electrode used to prevent the coupling between the sensor electrode and the floating capacitance. The voltage circuit is connected to the shield electrode and outputs a predetermined phase and an AC voltage of a predetermined voltage.

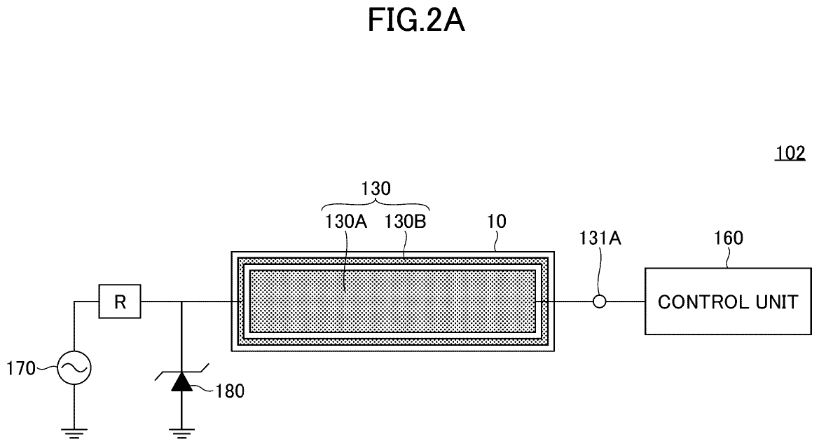

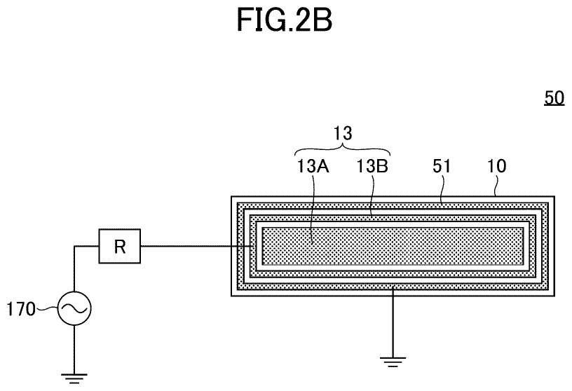

The protection circuit has a first end part connected to a connection part between the voltage circuit and the shield electrode and a second end part connected to a ground. Details of the configuration of the capacitive sensor 130, the voltage circuit, and the protection circuit will be described later with reference to FIGS. 2 to 4.

A heater 140 for heating and warming the rim 110 is built into the rim 110. That is, the capacitive sensor 130 and the heater 140 are provided at different parts of the steering wheel 100.

As illustrated in FIG. 1D, the control unit 160 is electrically connected to the capacitive sensor 130. The output signal of the capacitive sensor 130 represents the capacitance of the capacitive sensor 130. The control unit 160 generates a detection signal based on the change in the capacitance of the capacitive sensor 130, compares the detection signal with a preset threshold, determines whether the driver's hands are approaching the steering wheel, and outputs a signal representing the determination result to an external device. FIG. 1D also illustrates a voltage circuit 170 and a Zener diode 180. The voltage circuit 170 and the Zener diode 180 will be described later with reference to FIG. 2A.

When the determination result is negative, the external device determines that the driver has not grasped the steering wheel by his or her hands and alerts the driver. The operation of the determining unit determining whether the driver's hands are approaching the steering wheel may be performed by the external device. In this case, the control unit 160 performs a coding process to facilitate communication with respect to the detection signal and transmits the detection signal to the external device.

As described above, in the steering wheel 100, the capacitive sensor 130 is arranged away from the heater 140, and, therefore, the tendency of the change of the capacitance of the capacitive sensor 130 is hardly affected by the capacitance of the heater 140. Further, the possibility of the detection signal generated by the control unit 160 based on the change of the capacitance of the capacitive sensor 130 being affected by the capacitance of the heater 140 is almost eliminated. Further, the possibility of the heat from the heater 140 being transmitted to the capacitive sensor 130 is almost eliminated, and, therefore, the control unit 160 can accurately detect whether a human hand is in contact with or close to the steering wheel without being affected by the heater 140. Further, the heater 140 can efficiently heat the rim 110 without being affected by the heat capacity of the capacitive sensor 130.

Incidentally, the control unit 160 can detect whether an operation body having a capacitance value, such as a human hand, is in contact or close proximity according to a change in the capacitance of the capacitive sensor 130, but because the value of the capacitance of the capacitive sensor 130 depends on the distance between the capacitive sensor 130 and the operation body to be detected, the value increases when the operation body approaches the capacitive sensor 130 and decreases when the operation body moves away. By using this, the control unit 160 can adjust the detection range by adjusting a threshold value to be compared with the value of the detection signal from the capacitive sensor 130 or by making a determination by using a plurality of thresholds. Specifically, the control unit 160 can determine that the operating body is in close proximity to the rim 110 even when the portion (130a, 130b) constituting the capacitive sensor 130 illustrated in FIG. 1A that is farthest from the rim 110 is used. Therefore, for example, the control unit 160 determines that the operating body is located between the rim 110 illustrated in FIG. 1B and the capacitive sensor 130 provided along the edges 121a, 121b, 121c of the spoke 120 facing the inner peripheral surface of the rim 110 and in the detection regions 150a, 150b, 150c set around the rim 110.

In first embodiment, the capacitive sensor 130 is incorporated in the steering wheel sensor 102, and the steering wheel sensor 102 is covered on the driver side by an appearance panel 125 illustrated in FIG. 1C. The capacitive sensor 130 is formed of a conductive body such as a conductive body pattern and is provided along the edge of the spoke 120. The capacitive sensor 130 is provided at a position facing the inner periphery of the rim 110 of the spoke 120. The detection regions 150a, 150b, 150c extend along the plane direction including the rim 110 as illustrated in FIG. 1B.

Further, as illustrated in FIG. 1A, specifically, the rim 110 and the spoke 120 are connected to each other in the inner side of the rim 110 at the connection parts 120a, 120b, 120c with the spoke 120. Further, a groove slightly larger than the thickness of the capacitive sensor 130 is provided along the outer peripheral edge of the spoke 120 to hold the capacitive sensor 130 as illustrated in FIG. 1A, but the capacitive sensor 130 may be held on the outer surface of the spoke 120 facing the rim 110.

The sensor electrode 130A of the steering wheel sensor 102 has a portion 130a provided along the edge 121a of the spoke 120 facing the rim 110. A portion 130b is provided along the edge 121b of the spoke 120 facing the rim 110. Portions 130c, 130d are partially provided along the edge 121c of the spoke 120 facing the rim 110. A portion 130e is provided at the connection part 120a where the spoke 120 is connected to the rim 110, and a portion 130f is provided along the connection part 120b.

A portion 130e of the sensor electrode 130A is provided along the connection part 120a at the connection part 120a where the spoke 120 is connected to the rim 110, a portion 130f of the sensor electrode 130A is provided along the connection part 120b at the connection part 120b, and a portion 130g of the sensor electrode 130A is provided along the connection part 120c at the connection part 120c. A shield electrode 130B is provided around the portions 130a to 130g.

As illustrated in FIG. 1C, the capacitive sensor 130 is formed by the substrate 10, the portions 130a to 130g, which are provided on the surface of the substrate 10 and function as sensor electrodes, and the shield electrode 130B, which is provided around the portions 130a to 130g, and the portions 130c, 130f, 130a, 130e, 130b, 130g, and 130d are formed and arranged in the stated order, and are arranged along the edges 121a to 121c and the connection parts 120a to 120c of the spoke 120. In first embodiment, the capacitive sensor 130 is formed of seven portions 130a to 130g, but the capacitive sensor 130 may be formed of two portions: a portion corresponding to a portion of the portion 130e, the portion 130a, the portion 130f, the portion 130c; and a portion corresponding to another portion of the portion 130e, the portion 130b, the portion 130g, the portion 130d, or the capacitive sensor 130 may be formed of any other number of portions. Although the portions 130a to 130g are longitudinally divided along the edge of the spoke 120, these portions may be formed along the edge of the spoke 120 and simultaneously divided into a plurality of portions such as two portions in the short-hand direction (the direction of the sheet of FIG. 1A). That is, the capacitive sensor 130 includes edges (121a, 121b) and connection parts (120a, 120b, 120c), and is continuously provided along the outer periphery of the spoke.

For example, when the lower portion 110a of the rim 110 is gripped by a human hand, the steering wheel 100 approaches the portion 130a of the capacitive sensor 130 and enters the detection region 150a, so that a human hand can be detected. Further, when the lower portion 110b of the rim 110 is gripped by a human hand, the steering wheel 100 approaches the portion 130b of the capacitive sensor 130 and enters the detection region 150b, so that a human hand can be detected.

Further, when a human drives a vehicle, a human hand may touch the connection part of the spoke 120 with the rim 110 or the vicinity thereof when operating the vehicle. For example, when a human hand touches the connection part 120a of the spoke 120 or the vicinity thereof, a human hand approaching the portion 130e of the capacitive sensor 130 enters the detection region 150a or 150b, and is thus detected by the control unit 160. Alternatively, a human hand approaching the portion 130e of the capacitive sensor 130 approaches the connection part 120a side of the portion 130a of the capacitive sensor 130 or the connection part 120a side of the portion 130b of the capacitive sensor 130 and enters the detection region 150a or 150b and is thus detected by the control unit 160.

Further, when a human hand touches the connection part 120b of the spoke 120 or the vicinity thereof, the human hand approaches the portion 130f, the portion 130c, or the like of the capacitive sensor 130 and enters the detection region 150c and is thus detected by the control unit 160. When a human hand touches the connection part 120c of the spoke 120 or the vicinity thereof, the human hand approaches the portion 130g, the portion 130d, or the like of the capacitive sensor 130 and enters the detection region 150d, and is thus detected by the control unit 160.

The capacitive sensor may also be provided in the portion between the portion 130c and the portion 130d of the capacitive sensor 130 along the upper edge of the hub 115 facing the inner peripheral surface of the rim 110. In this case, it is possible to detect that a human hand is also touching the upper edge of the hub 115 facing the inner peripheral surface of the rim 110 and the upper side of the rim 110.

### <Configuration of the Capacitive Sensor 130>

FIG. 2A illustrates a configuration of the steering wheel sensor 102 including the capacitive sensor 130. The steering wheel sensor 102 includes the capacitive sensor 130, a resistor R, the control unit 160, the voltage circuit 170, and the Zener diode 180.

The capacitive sensor 130 includes a substrate 10 (an example of a “base material”), a sensor electrode 130A, and a shield electrode 130B. The longitudinal direction (transverse direction in FIG. 2A) of the capacitive sensor 130 in FIG. 2A is the direction in which the portions 130c, 130f, 130a, 130e, 130b, 130g, and 130d extend in FIGS. 1A to 1C, and the short-hand direction (transverse direction in FIG. 2A) is the direction of the sheet of FIGS. 1A and 1B. Further, in FIG. 2A, the portions 130c, 130f, 130a, 130e, 130b, 130g, and 130d are collectively illustrated as the sensor electrode 130A for easy understanding of the configuration.

The substrate 10 is a plate-like wiring substrate, and as an example, a flexible substrate made of polyimide or the like can be used. A sensor electrode 130A and a shield electrode 130B are formed on one surface of the substrate 10. In the following, in a state before the substrate 10 is attached to the spoke 120, a planar view is referred to as a view when the substrate 10 is extended in a planar manner as illustrated in FIG. 2A. The substrate 10 is actually a rectangular shape that is very long in the longitudinal direction in a flat view. In FIG. 2A, the substrate 10 is illustrated to be shortened in the longitudinal direction.

In a planar view, the sensor electrode 130A is an electrode having a plurality of rectangular portions 130a to 130g formed on one surface of the substrate 10 between one end and the other end in the longitudinal direction of the substrate 10. The shield electrode 130B is a rectangular annular electrode formed on one surface of the substrate 10 so as to surround the outer edge of the sensor electrode 130A. The shield electrode 130B surrounds the sensor electrode 130A in planar view and is formed along the outer edge of the sensor electrode 130A in the vicinity of the sensor electrode 130A. The shield electrode 130B may be further provided on a surface opposite to the surface on which the sensor electrode 130A is formed on the substrate 10.

The sensor electrode 130A and the shield electrode 130B are capacitively coupled. As an example, the sensor electrode 130A and the shield electrode 130B can be implemented by a thin metal layer made of metal. As an example, the sensor electrode 130A and the shield electrode 130B can be made of a metal such as copper or aluminum.

The sensor electrode 130A has a terminal 131A. The sensor electrode 130A is connected to the control unit 160 through the terminal 131A. Although portions 130a, 130e, and 130b of the sensor electrode 130A are not illustrated in FIG. 1D, in practice, portions 130a to 130g of the sensor electrode 130A are connected to the control unit 160 through the terminals 131A. The shield electrode 130B is connected to the voltage circuit 170 through the resistor R. The resistor R is provided to enable the voltage at the connection part between the shield electrode 130B and the voltage circuit 170 to be greater than or equal to the breakdown voltage in the opposite direction of the Zener diode 180 when a hand that is charged with static electricity touches the spoke 120. By providing such a resistor R at the connection part between the shield electrode 130B and the voltage circuit 170, when a hand that is charged with static electricity touches the spoke 120, the electrostatic charge can be discharged to the shield electrode 130B whose creepage distance from the hand is closer than that of the sensor electrode 130A, and the instantaneous high current can be prevented from flowing from the shield electrode 130B to the voltage circuit 170, while the instantaneous high current can be prevented from flowing from the sensor electrode 130A to the control unit 160.

The voltage circuit 170 outputs an AC voltage of a predetermined frequency, a predetermined phase, and a predetermined voltage, and the AC voltage is applied to the shield electrode 130B. The sensor electrode 130A is capacitively coupled with the shield electrode 130B, and, therefore, the AC voltage is applied to the sensor electrode 130A through the shield electrode 130B. The AC voltage having the same frequency, phase, and amplitude as the AC voltage applied to the shield electrode 130B is applied to the sensor electrode 130A.

By applying the AC voltage having the same frequency, phase, and amplitude to the sensor electrode 130A and the shield electrode 130B as described above, no charge is generated in the capacitor between the sensor electrode 130A and the shield electrode 130B, and, therefore, the influence of the ground is eliminated and the capacitance between the operation body and the sensor electrode 130A can be accurately detected. Thus, by applying AC voltage of the same frequency, the same phase, and the same amplitude to the sensor electrode 130A and the shield electrode 130B, an active shield can be implemented, and the influence of the floating capacitance between the sensor electrode 130A and the ground or the like can be eliminated.

The voltage circuit 170 may be connected to both the sensor electrode 130A and the shield electrode 130B, and AC voltage of the same frequency, the same phase, and the same amplitude may be applied from the voltage circuit 170 to both the sensor electrode 130A and the shield electrode 130B.

If the effect of the active shield is not impaired, the amplitude of the AC voltage applied to the sensor electrode 130A may be different from the amplitude of the AC voltage applied to the shield electrode 130B.

The cathode (an example of the “first end part”) of the Zener diode 180 (an example of the “protection circuit”) is connected to the connection part between the shield electrode 130B and the voltage circuit 170. The anode (an example of the “second end part”) of the Zener diode 180 is connected to the ground.

If the human hand is charged with static electricity when the hand touches the spoke 120 of the steering wheel 100, a large current flows instantaneously from the shield electrode 130B to the voltage circuit 170 due to the discharge of static electricity, and the control unit 160 may be damaged. In order to prevent such damage of the voltage circuit 170, the Zener diode 180 as a protection circuit is provided.

When the voltage (positive voltage of AC voltage) of the shield electrode 130B is less than the breakdown voltage (Zener voltage) in the reverse direction of the Zener diode 180, no reverse current (Zener current) flows through the Zener diode 180, and the shield electrode 130B functions as an active shield.

Further, when a hand which is charged with static electricity touches the spoke 120 and the voltage at the connection part between the shield electrode 130B and the voltage circuit 170 becomes greater than or equal to the breakdown voltage in the reverse direction of the Zener diode 180, a reverse current flows through the Zener diode 180, and a large current instantaneously generated by static electricity flows toward the ground. Therefore, it is possible to prevent a large current from instantaneously flowing from the shield electrode 130B toward the voltage circuit 170, and damage to the voltage circuit 170 can be prevented. At the same time, the shield electrode 130B is arranged around the sensor electrode 130A, and the shield electrode 130B exists in the space between the hand and the sensor electrode 130A, and, therefore, static electricity is not discharged to the sensor electrode 130A, and damage to the control unit 160 connected to the sensor electrode 130A can be prevented.

### <Sensor Apparatus 50 for Comparison>

FIG. 2B illustrates a sensor apparatus 50 for comparison. The sensor apparatus 50 for comparison illustrated in FIG. 2B is not a prior art but is fabricated for comparison.

The sensor apparatus 50 for comparison illustrated in FIG. 2B includes a substrate 10, a capacitive sensor 13 (the sensor electrode 13A and the shield electrode 13B), a ground electrode 51, a resistor R, and a voltage circuit 170. The substrate 10 is the same size and type of substrate as that of the steering wheel sensor 102 (sensor apparatus) of the first embodiment.

The sensor apparatus 50 for comparison differs from the steering wheel sensor 102 (sensor apparatus) of first embodiment in that a ground electrode 51 is provided on one surface of the substrate 10 in addition to the capacitive sensor 13 (the sensor electrode 13A and the shield electrode 13B), and a Zener diode 180 is excluded. The capacitive sensor 13 having the sensor electrode 13A and the shield electrode 13B has a configuration in which the sensor electrode 130A and the shield electrode 130B of the capacitive sensor 130 of the steering wheel sensor 102 (sensor apparatus) of first embodiment are made planarly small. A rectangular annular ground electrode 51 is provided on the outside of the shield electrode 13B. The ground electrode 51 is connected to the ground.

In such a comparative sensor apparatus 50, when a hand charged with static electricity approaches, a large current instantaneously generated by the static electricity flows toward the ground through the ground electrode 51. Therefore, the large current is prevented from instantaneously flowing from the sensor electrode 13A toward the control unit 160, and the control unit 160 can be prevented from being damaged.

However, the rectangular annular ground electrode 51 is provided outside the shield electrode 13B of the capacitive sensor 13, and, therefore, when the substrate 10 of the same size is used, the capacitive sensor 13 becomes smaller than the capacitive sensor 130 of the steering wheel sensor 102 (sensor apparatus) of first embodiment.

Therefore, there arises a problem that the sufficient capacitance between the sensor electrode 13A and the hand cannot be obtained and that the sensitivity gain of the sensor electrode 13A cannot be sufficiently increased, and a problem that the noise component increases as the unnecessary capacitance increases between the ground electrode 51 and the sensor electrode 13A and the shield electrode 13B, and that the S/N (signal/noise ratio) characteristic is degraded. There also arises a problem that the S/N characteristic is degraded because the electric force line generated in the sensor electrode 13A is attracted to the nearby ground electrode 51 and the electric force line between the sensor electrode 13A and the hand decreases, and there also arises a problem that the S/N characteristic decreases because the area of the capacitive sensor 13 (the sensor electrode 13A and the shield electrode 13B) is narrowed by arranging the ground electrode 51.

On the other hand, in the steering wheel sensor 102 (sensor apparatus) of first embodiment, the area of the sensor electrode 130A can be larger than that of the sensor electrode 13A of the sensor apparatus 50 for comparison. Therefore, the sensitivity gain of the sensor electrode 130A can be sufficiently increased. Further, the sensor electrode 130A does not generate unnecessary capacitance, and good S/N characteristics can be obtained. Furthermore, the reduction of the electric force line generated in the sensor electrode 130A can be prevented, and the S/N characteristics can be improved. Further, the area of the sensor electrode 130A becomes larger (wider), and the S/N characteristics can be improved.

Further, the overall size of the capacitive sensor 130 can be made smaller because the ground electrode 51 of the sensor apparatus 50 for comparison is not included.

As described above, active shielding can be implemented with the shield electrode 130B. Further, the cathode is connected to the connection part between the shield electrode 130B and the voltage circuit 170, and the anode includes a Zener diode 180 connected to the ground, and, therefore, even if a large current is instantaneously generated by static electricity, the Zener diode 180 can be reversed so that the current can flow to the ground.

Therefore, it is possible to provide a steering wheel sensor 102 (sensor apparatus) capable of preventing the influence of the floating capacitance on the detection value of the sensor electrode 130A and the damage of the voltage circuit 170 and the control unit 160 caused by static electricity.

Further, in comparison with the configuration in which the ground electrode 51 is provided around the shield electrode 13B as in the sensor apparatus 50 for comparison illustrated in FIG. 2B, miniaturization can be achieved because the ground electrode 51 is not included. Further, when the substrate 10 having the same size as the sensor apparatus 50 for comparison is used, the sensor electrode 130A can be enlarged, so that excellent S/N characteristics can be obtained.

The shield electrode 130B surrounds the sensor electrode 130A, and, therefore, even if static electricity is generated at any position around the sensor electrode 130A, static electricity can be absorbed by the shield electrode 130B, and static electricity can be prevented from flowing to the sensor electrode 130A. That is, effective ESD (Electro-Static Discharge) countermeasures can be applied to the sensor electrode 130A.

Further, the voltage circuit 170 is connected to the sensor electrode 130A, and the AC voltage of the same phase as the shield electrode 130B is supplied to the sensor electrode 130A, and, therefore, the influence of the ground is eliminated, and the capacitance between the operation body and the sensor electrode 130A can be accurately detected.

The AC voltage of the same voltage (same amplitude) as the shield electrode 130B is supplied to the sensor electrode 130A, and, therefore, the influence of the ground is eliminated, and the capacitance between the operation body and the sensor electrode 130A can be more accurately detected.

Further, the sensor electrode 130A and the shield electrode 130B are provided along the edges 121a, 121b, 121c of the spoke 120 facing the rim 110 of the steering wheel 100 having the rim 110, the spoke 120, and the hub 115, and, therefore, it is possible to determine whether the driver's hands are placed at positions to immediately operate the steering wheel 100. Even in a configuration in which the heater 140 is incorporated in the rim 110, it is possible to determine whether the driver's hands are placed at positions to immediately operate the steering wheel 100.

### First Modified Example of First Embodiment

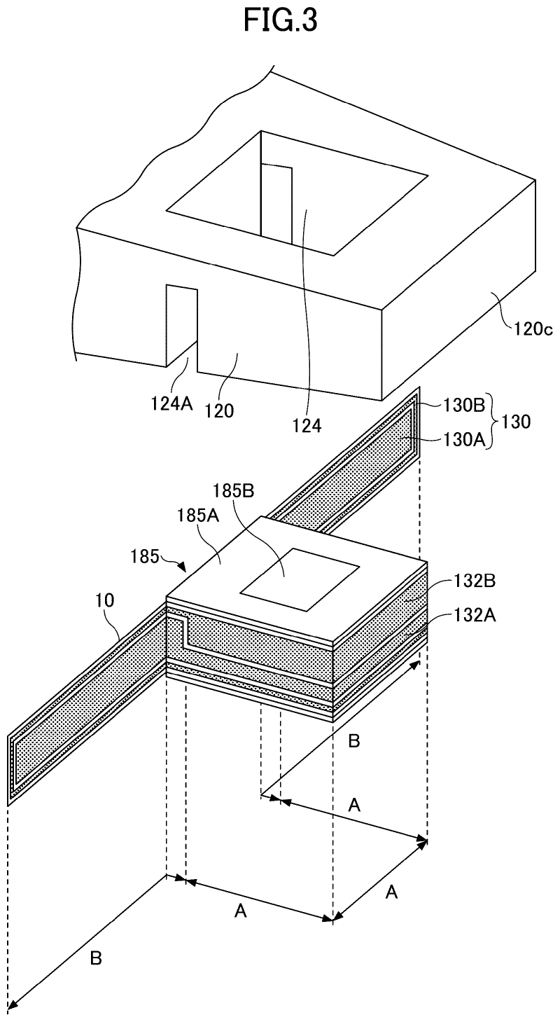

FIG. 3 is a diagram illustrating a configuration of a portion of the spoke 120 of the steering wheel 100 and the periphery thereof in the first modified example of first embodiment. FIG. 3 illustrates, as an example, the spoke 120 positioned on the right side of the steering wheel 100 in a neutral state. In FIG. 3, the rim 110 and the hub 115 are omitted.

The spoke 120 is provided with a housing part 124 for housing the steering switch 185 and a notch 124A. The housing part 124 is a recessed part. The notch 124A communicates with the end part of the housing part 124 on the hub 115 side (the center side of the steering wheel 100), and is a groove provided on the rear side of the spoke 120 in a direction substantially perpendicular to (the vertical direction in the state where the steering wheel 100 is attached to the vehicle) the extending direction of the spoke 120 (the radial direction of the steering wheel 100). The notch 124A is provided vertically at the end part of the housing part 124 on the hub 115 side.

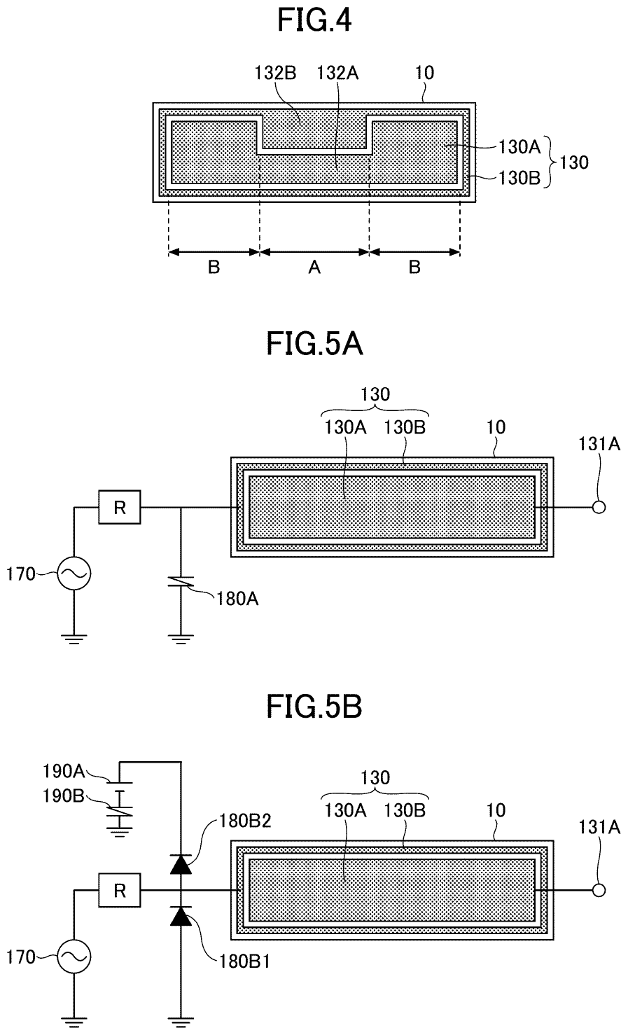

The steering switch 185 has a casing 185A and an operation unit 185B. The casing 185A is a case made of resin, and is fit into the housing part 124 from the back side of the spoke 120 (lower side in FIG. 3) with the center part (section A in FIG. 4 to be described later) in the extending direction (direction in which the sections A and B in FIG. 4 to be described later extend) of the capacitive sensor 130 (sensor electrode 130A and the shield electrode 130B) adhered to the side surface. At this time, the section outside the center part in the extending direction of the capacitive sensor 130 (section B in FIG. 4 to be described later) is passed into the notch 124A. The operation unit 185B is an operation unit implemented by a dial switch or a button switch, etc.

Herein, the description will be made with reference to FIG. 4 in addition to FIG. 3. FIG. 4 is a diagram illustrating a capacitive sensor 130. The capacitive sensor 130 is attached to the casing 185A by adhering the substrate 10 to the side surface of the casing 185A. More specifically, the section A portion of the capacitive sensor 130 is adhered to the side surface of the casing 185A (three sides in FIG. 3 as an example) as illustrated in FIG. 3, and the section B portion is not adhered to the side surface of the casing 185A.

When the capacitive sensor 130 is adhered to the side surface of the casing 185A in this manner, and the steering switch 185 is fit into the housing part 124 from the rear side of the spoke 120, the sensor electrode 130A and the shield electrode 130B face the inner peripheral side of the rim 110. At this time, the portion adjacent to the section A of the two sections B located on both ends of the capacitive sensor 130 in the extending direction is inserted into the notch 124A. In this manner, the sensor electrode 130A and the shield electrode 130B are provided in the casing 185A of the steering switch 185 so as to face the inner peripheral side of the rim 110 while the steering switch 185 is housed in the housing part 124.

In FIG. 4, the transverse direction is the extending direction of the sensor electrode 130A, and the width of the sensor electrode 130A is the longitudinal direction in FIG. 4. Similarly, the width of the shield electrode 130B is the longitudinal width perpendicular to the direction extending along the sensor electrode 130A (the transverse direction in FIG. 4).

The sensor electrode 130A has a narrowed width portion 132A having a narrowed width in the section A where the steering switch 185 exists. The shield electrode 130B has a widened width portion 132B having a widened width in the section A where the steering switch 185 exists. As described above, the sensor electrode 130A has the narrowed width portion 132A and the shield electrode 130B has the widened width portion 132B, and, therefore, the width of the shield electrode 130B relative to the width of the sensor electrode 130A is wider in the section A where the steering switch exists than in the section B where the steering switch does not exist.

In the section where the steering switch 185 exists, there is a risk that a large instantaneous current may flow when a hand charged with static electricity touches the spoke 120, and, therefore, by providing the widened width portion 132B to the shield electrode 130B, the large instantaneous current caused by static electricity can be more reliably captured by the shield electrode 130B and passed to the ground via the Zener diode 180.

Therefore, by using the widened width portion 132B in the shield electrode 130B, it is possible to provide a steering wheel sensor 102 (sensor apparatus) which can prevent the influence of the floating capacitance on the detection value of the sensor electrode 130A and can more effectively prevent damage to the voltage circuit 170 and the control unit 160 caused by static electricity.

### Second Modified Example of First Embodiment

FIG. 5A illustrates the configuration of the capacitive sensor 130 according to the second modified example of first embodiment. In the capacitive sensor 130 according to the second modified example of first embodiment, a varistor 180A is used instead of the Zener diode 180 illustrated in FIG. 2A.

When the voltage (positive voltage of AC voltage) of the shield electrode 130B is less than the varistor voltage of the varistor 180A, no current flows through the varistor 180A, and the shield electrode 130B functions as an active shield.

When a hand charged with static electricity touches the spoke 120 and the voltage of the shield electrode 130B becomes greater than or equal to the varistor voltage of the varistor 180A, a current flows through the varistor 180A, and a large current generated instantaneously by static electricity flows toward the ground. Therefore, it is possible to prevent a large current flowing instantaneously from the shield electrode 130B toward the voltage circuit 170, and to prevent damage to the voltage circuit 170. At the same time, it is possible to reduce the possibility of electrostatic discharge to the sensor electrode 130A, so that it is possible to prevent a large current flowing instantaneously from the sensor electrode 130A toward the control unit 160, and to prevent damage to the control unit 160.

### Third Modified Example of First Embodiment

FIG. 5B is a diagram illustrating the configuration of the capacitive sensor 130 according to the third modified example of first embodiment. In the capacitive sensor 130 according to the third modified example of first embodiment, diodes 180B1 and 180B2 are used instead of the Zener diode 180 illustrated in FIG. 2A. The diodes 180B1 and 180B2 are an example of a protection circuit.

Similar to the Zener diode 180 in FIG. 2A, the diode 180B1 has an anode connected to the ground and a cathode connected to a connection part between the shield electrode 130B and the voltage circuit 170. The first end part of the diode 180B1 as the protection circuit is the cathode and the second end part is the anode.

In the diode 180B2, the anode is connected to the connection part between the shield electrode 130B and the voltage circuit 170, and the cathode is connected to the positive polarity terminal of the DC power supply 190A. The negative polarity terminal of the DC power supply 190A is connected to the ground through the varistor 190B. The first end part of the diode 180B2 as a protection circuit is an anode and the second end part is a cathode.

When the voltage difference between the voltage of the shield electrode 130B (negative voltage of the AC voltage) and the voltage of the ground (0 V) is less than the forward voltage of the diode 180B1 and the voltage difference obtained by subtracting the voltage of the positive polarity terminal of the DC power supply 190A from the voltage of the shield electrode 130B is less than the forward voltage of the diode 180B2, no forward current flows through the diode 180B1 and no forward current flows through the diode 180B2. In this state, the shield electrode 130B functions as an active shield.

Further, when a hand charged with static electricity touches the spoke 120, and the voltage difference between the voltage of the shield electrode 130B (negative voltage of the AC voltage) and the voltage of the ground (0 V) becomes greater than or equal to the forward voltage of the diode 180B1, a current flows from the ground to the shield electrode 130B through the diode 180B1, and a large current generated instantaneously by static electricity flows toward the ground.

When a hand charged with static electricity touches the spoke 120, and the voltage difference obtained by subtracting the voltage of the positive polarity terminal of the DC power supply 190A from the voltage of the shield electrode 130B becomes greater than or equal to the forward voltage of the diode 180B2, a current flows from the shield electrode 130B to the DC power supply 190A through the diode 180B2, and a current flows to the varistor 190B. That is, a large current generated instantaneously by static electricity flows from the shield electrode 130B to the ground through the diode 180B2, the DC power supply 190A, and the varistor 190B.

Therefore, it is possible to prevent a large current from flowing instantaneously from the shield electrode 130B toward the voltage circuit 170, and to prevent damage to the voltage circuit 170. At the same time, the possibility of electrostatic discharge to the sensor electrode 130A can be reduced, and, therefore, it is possible to prevent the instantaneous flow of a large current from the sensor electrode 130A toward the control unit 160, and to prevent the damage of the control unit 160.

### Second Embodiment

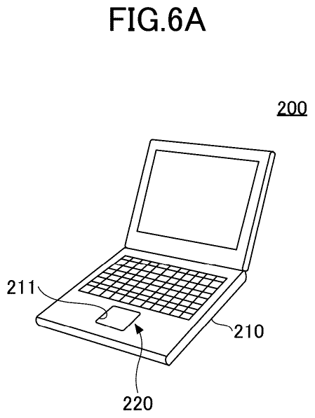

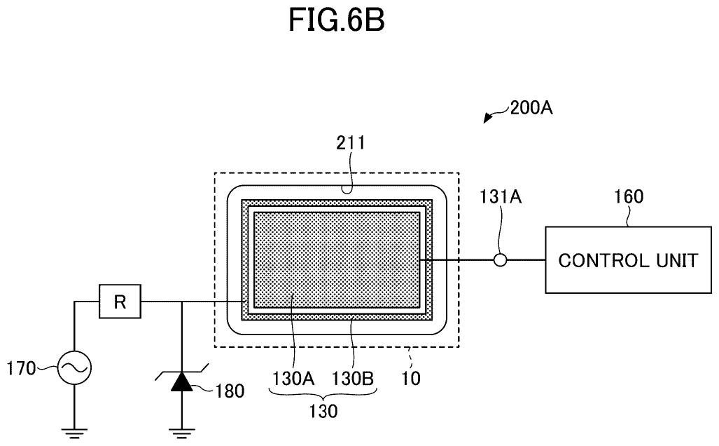

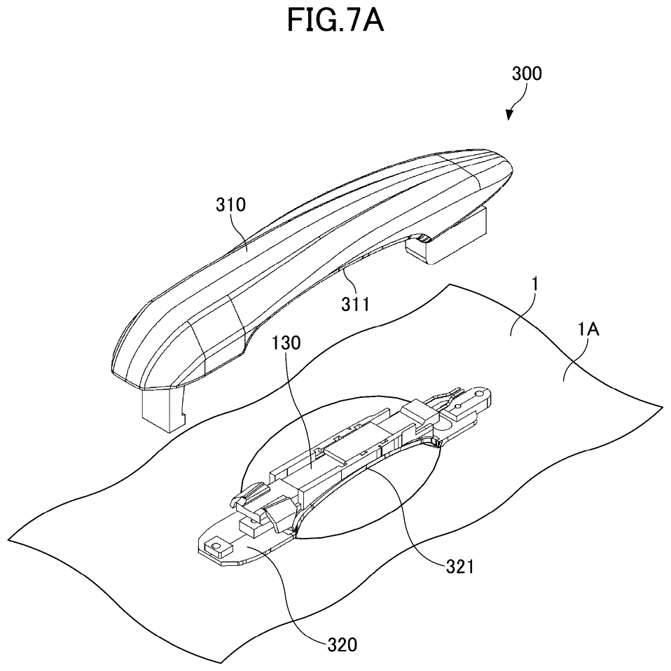

FIG. 6A illustrates a PC (Personal Computer) 200 including the sensor apparatus of a second embodiment. The PC 200 has a casing 210 and a touch pad 220. The description of the elements other than the casing 210 and the touch pad 220 among the elements of the PC 200 will be omitted here. The casing 210 has an opening part 211 that exposes the touch pad 220.

FIG. 6B is a view illustrating the sensor apparatus 200A of the second embodiment. The sensor apparatus 200A includes a sensor electrode 130A, a shield electrode 130B, a control unit 160, a resistor R, a voltage circuit 170, and a Zener diode 180.

The capacitive sensor 130 of the sensor apparatus 200A is provided on the back side of the cover of the touch pad 220. As illustrated in FIG. 6B, the capacitive sensor 130 of the sensor apparatus 200A has a sensor electrode 130A and a shield electrode 130B corresponding to the size of the touch pad 220 (FIG. 6A). The sensor electrode 130A and the shield electrode 130B are provided inside the casing 210 (see FIG. 6A) and are arranged inward of the opening edge of the opening part 211 of the casing 210 in planar view as illustrated in FIG. 6B.

When the voltage (positive voltage of AC voltage) of the shield electrode 130B is less than the breakdown voltage (Zener voltage) in the reverse direction of the Zener diode 180 when the touch pad 220 is operated, no reverse current (Zener current) flows through the Zener diode 180, and the shield electrode 130B functions as an active shield.

When the hand which is charged with static electricity touches the touch pad 220 when operating the touch pad 220, and the voltage of the connection part between the shield electrode 130B and the voltage circuit 170 becomes greater than or equal to the breakdown voltage in the reverse direction of the Zener diode 180, the reverse current of the Zener diode 180 flows, and a large current instantaneously generated by static electricity flows toward the ground.

Therefore, the large current instantaneously flowing from the shield electrode 130B toward the voltage circuit 170 can be prevented, and the damage of the voltage circuit 170 can be prevented. At the same time, the possibility of electrostatic discharge to the sensor electrode 130A can be reduced, and, therefore, it is possible to prevent the instantaneous flow of a large current from the sensor electrode 130A toward the control unit 160, and to prevent the damage of the control unit 160.

In particular, the shield electrode 130B is arranged inward of the opening edge of the opening part 211 in a planar view, and, therefore, even if electrostatic charge penetrates into the interior of the opening edge of the opening part 211, the instantaneous large current caused by electrostatic charge can flow toward the ground from the shield electrode 130B through the Zener diode 180, thereby effectively preventing the damage of the voltage circuit 170 and the control unit 160. The shield electrode 130B functions as an active shield, and, therefore, the influence of the floating capacitance on the detection value of the sensor electrode 130A can be reduced.

Therefore, the sensor apparatus 200A provided on the touch pad 220 can prevent the influence of the floating capacitance on the detection value of the sensor electrode 130A and the damage of the voltage circuit 170 and the control unit 160 caused by static electricity.

### Third Embodiment

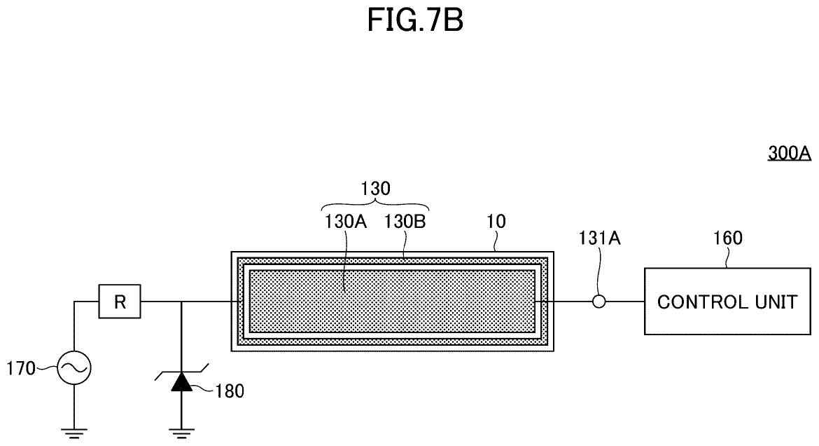

FIG. 7A illustrates a door handle (an example of a handle) 300 to which the sensor apparatus of the third embodiment is applied. The door handle case serving as a casing part of the door handle 300 includes an outer case 310 and an inner case 320, and a capacitive sensor 130 is provided inside the case covered by the outer case 310 and the inner case 320. The inner case 320 is an example of a first case made of an insulator attached to a vehicle body 1 along an outer surface 1A of the vehicle body 1, and the outer case 310 is an example of a second case made of an insulator attached to the inner case 320 (first case).

FIG. 7B is a diagram illustrating the sensor apparatus 300A of the third embodiment. The sensor apparatus 300A includes a sensor electrode 130A, a shield electrode 130B, a control unit 160, a resistor R, a voltage circuit 170, and a Zener diode 180.

The capacitive sensor 130 of the sensor apparatus 300A is provided inside the door handle 300. As illustrated in FIG. 7B, the capacitive sensor 130 of the sensor apparatus 300A has a sensor electrode 130A and a shield electrode 130B corresponding to the size of the door handle 300 (FIG. 7A). The shield electrode 130B is provided along the joint of the outer case 310 and the inner case 320 of the door handle 300. The joint of the outer case 310 and the inner case 320 is a part where the edge 311 of the inner case 320 of the outer case 310 and the edge 321 on the outer case 310 side of the inner case 320 are joined. At least a part of the shield electrode 130B may be provided along the joint of the outer case 310 and the inner case 320 of the door handle 300.

When operating the door handle 300, when the voltage (positive voltage of AC voltage) of the shield electrode 130B is less than the breakdown voltage (Zener voltage) in the reverse direction of the Zener diode 180, no reverse current (Zener current) flows through the Zener diode 180, and the shield electrode 130B functions as an active shield.

When operating the door handle 300, when a hand charged with static electricity touches the door handle 300 and the voltage at the connection part between the shield electrode 130B and the voltage circuit 170 becomes greater than or equal to the breakdown voltage in the reverse direction of the Zener diode 180, the reverse current of the Zener diode 180 flows, and a large current instantaneously generated by static electricity flows toward the ground.

Therefore, the large current instantaneously flowing from the shield electrode 130B toward the voltage circuit 170 can be prevented, and the damage of the voltage circuit 170 can be prevented. At the same time, the possibility of electrostatic discharge to the sensor electrode 130A can be reduced, and, therefore, the large current instantaneously flowing from the sensor electrode 130A toward the control unit 160 can be prevented, and the damage of the control unit 160 can be prevented.

In particular, the shield electrode 130B is arranged along the joint of the outer case 310 and the inner case 320, and, therefore, even if electrostatic charge penetrates into the interior through the gap at the joint of the outer case 310 and the inner case 320, the large instantaneous current caused by electrostatic charge can flow toward the ground from the shield electrode 130B through the Zener diode 180, and the damage of the voltage circuit 170 and the control unit 160 can be effectively prevented. The shield electrode 130B functions as an active shield, and, therefore, the influence of the floating capacitance on the detection value of the sensor electrode 130A can be reduced.

Therefore, it is possible to provide a sensor apparatus 300A provided on the door handle 300 and capable of preventing the influence of the floating capacitance on the detection value of the sensor electrode 130A and the damage of the voltage circuit 170 and the control unit 160 caused by static electricity.

A sensor apparatus capable of preventing the influence of the floating capacitance on the detection value of a sensor electrode and the damage caused by static electricity can be provided.

Although the sensor apparatus of the exemplary embodiment of the present disclosure has been described above, the present disclosure is not limited to the specifically disclosed embodiment and can be modified and changed in various ways without departing from the scope of claims.

What is claimed is:

1. A sensor apparatus comprising:
a sensor electrode provided on a base material;
a shield electrode provided on the base material so as to surround an outer edge of the sensor electrode and configured to capacitively couple with the sensor electrode;
a voltage circuit connected to the shield electrode and configured to output an AC voltage having a predetermined phase and a predetermined voltage; and
a protection circuit including a first end part connected to a connection part between the voltage circuit and the shield electrode and a second end part connected to ground.

2. The sensor apparatus according to claim 1, wherein
the voltage circuit is connected to the sensor electrode, and
the AC voltage having the predetermined phase is supplied to the sensor electrode.

3. The sensor apparatus according to claim 2, wherein the AC voltage having the predetermined voltage is supplied to the sensor electrode.

4. The sensor apparatus according to claim 1, wherein the sensor electrode and the shield electrode are provided inside a casing and are arranged inward of an opening edge of an opening part of the casing in a planar view.

5. The sensor apparatus according to claim 1, wherein
the sensor electrode and the shield electrode are arranged inside a handle including a first case made of an insulator and a second case made of an insulator attached to the first case, and
at least a part of the shield electrode is arranged along a joint of the first case and the second case.

6. The sensor apparatus according to claim 1, wherein the sensor electrode and the shield electrode are provided at a position of a spoke facing an inner peripheral side of a rim, the rim being of a steering wheel including the rim, the spoke, and a hub.

7. The sensor apparatus according to claim 6, wherein
the spoke includes a housing part configured to house a steering switch, and
the sensor electrode and the shield electrode are provided in a casing of the steering switch so as to face the inner peripheral side of the rim in a state where the steering switch is housed in the housing part.

8. The sensor apparatus according to claim 7, wherein with respect to a width of the sensor electrode, a width of the shield electrode is wider in a section where the steering switch exists than in a section where the steering switch does not exist.
